(19) United States
(12) Patent Application Publication
(10) Pub. No.: US 2003/0221005 A1
(43) Pub. Date: Nov. 27, 2003

(54) Device and method for classifying alarm messages resulting from a violation of a service level agreement in a communications network

(75) Inventors: Stephane Betge-Brezetz, Paris (FR); Gerard Delegue, Cachan (FR); Emmanuel Marilly, Antony (FR); Olivier Martinot, Draveil (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/434,056

(22) Filed: May 9, 2003

(30) Foreign Application Priority Data
May 23, 2002 (FR) 02 06 288

(51) Int. Cl. G06F 15/16; G06F 15/173

(52) U.S. Cl. 709/224; 709/207

(57) ABSTRACT

A service data control device inside a communications network includes control means (3) placed in such a way so as to classify according to at least one selected criterion alarm messages generated by detection means (2) when at least one specification of a service level, known as <<SLS>>, violation is detected on the basis of service data originating from the network and for delivering these classified alarm messages to a graphic interface (8) so that they are displayed according to their classification.

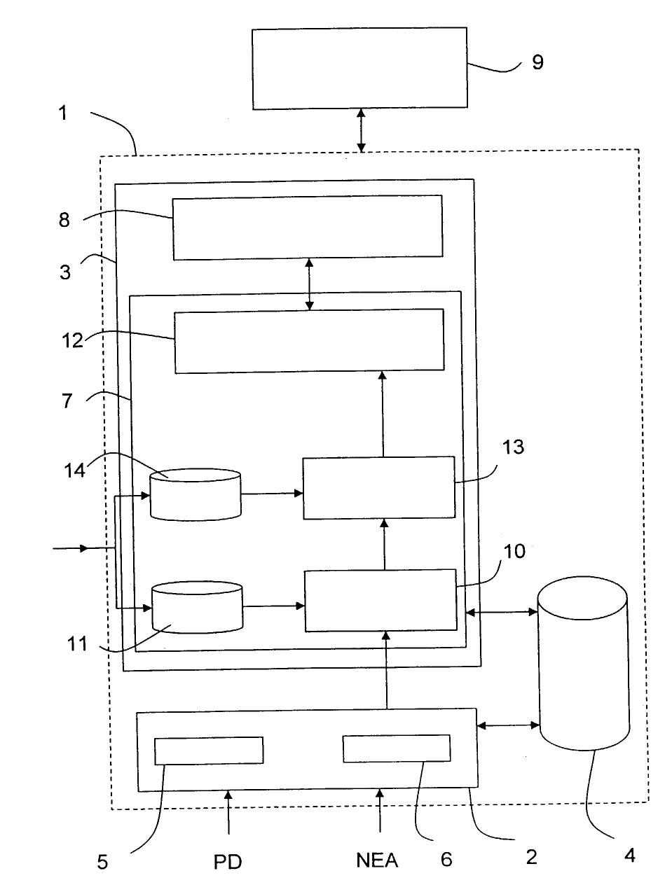

### FIELD OF THE INVENTION

The invention concerns the field of communications between terminals inside a network and more particularly that of control of the services offered to these terminals.

### BACKGROUND OF THE INVENTION

Owing to the continuous evolution of the equipment constituting the networks, the number and variety of the techniques implemented by this equipment and the number and variety of the services offered to customers who use the networks and their equipment, the operators of networks are increasingly confronted with problems of the management of priorities and service levels (or SLM for “Service Level management”).

Tools have been proposed to facilitate this management. But these tools generally deliver alarm messages if a problem is detected or likely to occur on an equipment item of the network (such as “TRAP” messages of the SNMP protocol) or concerning an element of the performance of the network. These tools are for example described in the patent applications US2002/019866 and W002/10944.

The solutions shown in these documents have a major drawback in that the network alarms are not classified and are thus difficult to by analyzed by the operator of the network management system.

In particular, even in the most advanced systems in which the network alarms are classified according to their level of severity and/or their origin, this classification taking into account neither the information relating to the service levels, nor those relating to priority levels which may vary from one customer to another and from one service to another.

Now certain network problems form the subject of a network alarm message when they do not have any real influence on the service level offered to the customer (this in particular being the case of router errors which are generally corrected by downstream routers), whereas other network problems result in a reduction of the service level below a specification without being made the subject of a network alarm message (this in particular is the case of certain congestions at the level of router interfaces which bring about a customer flow transmission delay). This is particularly awkward when this reduction provokes what experts in this particular field would call a violation of the service level agreement (SLA) concluded between an operator and a customer or a violation of the technical service level specification.

In addition, the current tools developed to manage the network alarm messages do not allow the operator to determine the severity of a Service Level Agreement (SLA) violation which depends in particular on the importance of the service and/or the customer concerned.

Moreover, certain tools deliver prediction alarm messages based on supposed evolution analyses of service data assumed to allow the operator to anticipate a future problem, but they do not allow him to analyze the severity of a predictive alarm message by taking into account a previous alarm message linked to a violation which has already occurred. Now a predictive alarm message can prove to be more critical for an “important” customer when an alarm message has already occurred concerning a less important customer.

### SUMMARY OF THE INVENTION

Thus, the object of the invention is to resolve all or part of said drawbacks.

To this effect, it offers a device for controlling service data inside a communications network, said device firstly including appropriate control means for classifying, according to at least one selected criterion, alarm messages generated by detection means when the latter detect the violation of at least one service level specification (SLS) subsequent to receiving service data from the network, and secondly to deliver these classified alarm messages to a graphic interface so that they are displayed according to their classification, for example on the control monitor of the operator of the network.

Thus, as the operator possesses alarm messages sorted according to the seriousness of the violation, he is able to concentrate on the operations to be taken to mitigate these violations in the best possible way.

The device of the invention could comprise a large number of additional characteristics able to be taken separately and/or in combination and in particular

Detection means including first analysis means for following up the evolution of at least some of the service data received so as to generate a predictive alarm message when this evolution is likely to result in an SLS violation;

Detection means including second analysis means so as to determine the origin of a violation inside the network;

Alarm messages generated by the detection means and comprising additional data selected from a group including at least one urgency level, a violation prediction reliability level, a user identification penalized by virtue of a violation, a violation status (predictive or occurred);

Detection means fed by a data base with first auxiliary data defining the SLS (or SLA) violations;

Control means including evaluation means for associating with each alarm message delivered by the detection means at least one violation level of at least one type selected according to at least one selected evaluation criterion. In this case, the evaluation criterion can be selected according to the additional data and/or by second auxiliary data representative for example of the priority levels attached to services or users. The evaluation means are preferably fed with second auxiliary data by the data base. In addition, the evaluation means can be configured, for example with the aid data defining rules (or “policies”);

Control means including correlation means for modifying at least one of the violation levels of an alarm message delivered by the evaluation means and having at least one selected relation with at least one of the previously received alarm messages. In this case, the correlation means can be configured, for example with the aid of data defining rules (or “policies”);

Control means including classification means for classifying the alarm messages and associated with at least one violation level type according to at least one selected classification criterion. In this case, the control means can comprise a table in which the various types SLS (or SLA) violation are stored according to one or several classification criteria, possibly being hierarchized. The classification criterion could for example relate to the various violation levels and/or additional parameters stored in the table, said parameters being able to be transmitted by the graphic interface when ordered by the operator.

The device of the invention can also comprise the data base containing the first and second auxiliary data and/or the detection means. Moreover, the control means of the device can integrate the graphic interface.

The invention also concerns a service data control method inside a communications network in which i) alarm messages are generated if a violation of at least one SLS is detected on the basis of service data originating from the network, ii) these alarm messages are classified according to at least one selected criterion, and iii) the alarm messages are displayed according to their classification.

The method of the invention could comprise a large number of additional characteristics able to be taken separately and/or in combination and in particular:

The evolution of at least some of the service data items received can be followed up so as to generate a predictive alarm message when this evolution is likely to lead to an SLS violation;

The origin of a violation inside the network can be determined before generating an alarm message;

The alarm messages can comprise additional data selected from a group including at least one urgent level, a violation prediction reliability level, a user identifier penalized by a violation, a service identifier penalized by a violation, and a violation status (predicted or occurred);

Prior to the classification operation, it is possible to associate with each alarm message at least one violation level of at least one selected type according to at least one selected evaluation criterion. This evaluation criterion can be selected according to additional data and/or second auxiliary data representative for example of priority levels attached to services and/or users. After this violation level association operation, it is possible to modify at least one of the violation levels of an alarm message having at least one selected relation with at least one of the alarm messages previously received. In this case, after the association operation and/or the modification operation, it is possible to classify the alarm messages, associated with at least one type of violation level according to one or several selected classification criteria, possibly hiearchized, the various types of SLS violation able to be stored in a table according to the classification criterion. In addition, the classification criterion can relate to the various violation levels and/or additional parameters stored in the table.

The invention can be implemented in any type of communications network, private or public, and in particular in Internet (IP), ATM and Frame Relay networks. In addition, the invention allows the control of a large number of services and in particular IP VPN, high flows, “Web” services, multimedia and 3G.

### BRIEF DESCRIPTION OF THE DRAWINGS

Other characteristics and advantages of the invention shall appear on an examination of the following detailed description and the sole accompanying FIGURE diagrammatically illustrating an embodiment of a device according to the invention. For the most part, this FIGURE has a particular nature. As a result, it could serve, not only to complete the invention, but also contribute in its definition, if required.

### DETAILED DESCRIPTION OF THE PREFERRED EMBODIMENTS

The device of the invention is intended to be installed at the heart of a communications network so as to control the service data concerning the flow of data exchanged by the customer terminals connected to said network. By way of non-restrictive example, it is considered in what follows that the network is the public Internet network in which the data is exchanged according to the IP protocol. However, it could concern a private Intranet type network or several public and/or private networks connected to one another. Furthermore, it is considered in the following that the customers of the network are linked to the operator by service (or SLA) agreements which include technical portions defined by service level specifications (or SLS).

The device 1 is preferably installed in a server controlled by the operator of the network.

The device 1 shown on the FIGURE comprises a detection module 2 and a control module 3 connected to each other and preferably fed, at least in part, by a main data base 4. This configuration is only one embodiment example. The device of the invention can in fact comprise only one control module 3 fed by an independent detection module 2.

The detection module 2 receives at least some of the service data from the network and preferably PD data representative of the performances of the network or at least one portion of the latter, as well as the alarms NEA transmitted by the equipment of the network, or at least one portion of them. The performance data PD are for example the passbands used and the flow measurements and the alarms NEA are for example transmitted by the routers and interfaces of the network.

In the example shown, the detection module 2 comprises firstly a first analysis (predictive) module 5 for following up the evolution of the service data PD and NEA so as to deliver “predictive” alarm messages when their evolution is likely to result in the violation of a service level specification, denoted hereafter by an “SLS violation”. This predictive analysis is based on forecast algorithms fed by the successive values of the various service data received within a selected time interval.

The detection module 2 preferably includes a second analysis module 6 intended to determine the cause of each SLS violation inside the network, especially on the basis of alarm messages NEA delivered by the equipment of the network. For example, this could be a routing error from a router or a malfunctioning at an interface. Each time the second analysis module 6 receives an alarm message NEA, it analyses it and if it feels that it has induced an SLS violation, it generates an alarm message, hereafter designated by “alarm message occurred” intended for the control module 3.

So as to properly carry out their analysis of service data PD and NEA, the analysis modules 5 and 6 use SLS violation definitions (or first auxiliary data) which in the example shown are stored in the main data base 4. Of course, when this data base is not provided, the SLS violation definitions are directly stored in the detection module 2.

Moreover, it is preferable to attach to the predictive and occurred alarm messages certain additional information so as to optimize its processing by the control module 3. This additional information is, for example, representative of the urgency level of the prediction of an SLS violation (period remaining before a predicted problem occurs), the level of reliability of the prediction of an SLS violation, the service identifier penalized by the SLS violation, the status of the SLS violation, that is the fact that it is predicted or already occurred.

The control module 3 includes an evaluation and classification module 7 coupled to the detection module 2 and to a graphic interface 8, for example of the Graphic User Interface type (GUI).

This graphic interface 8 in this example forms an integral part of the control module 3, but it could also be independent. It is also coupled to a user interface 9 of the server of the operator.

The classification and evaluation module 7 firstly comprises an evaluation module 10 fed with predictive and occurred alarm messages by the detection module 2. It is designed to estimate after each violation the severity of each SLS violation according to one or several parameterable evaluation criteria. The evaluation criteria are defined by an expert of the operator, for example in the form of rules (or “policies”) or formulae defined by data preferably stored in a first auxiliary data base 11 fed for example by the user interface 9. The rules and/or formulae contained in this auxiliary base 11 are preferably able to be modified dynamically.

Each time the evaluation module 10 receives a predictive or occurred alarm message, it associates with it at least one violation level of at least one selected type according to the evaluation criterion or criteria which correspond to the type of alarm message and the accompanying additional information (especially the urgency level (or intervention period) and the reliability level in the case of a predictive alarm message). The evaluation criterion selected for an alarm message is preferably also or alternately a function of second auxiliary data representative for example of the priority level of the service and/or the priority level (or importance) of the customer. This second auxiliary data is in the example shown stored in the main data base 4. Of course, when this data base is not provided, the second auxiliary data is stored directly in the evaluation module 10.

Amongst the large number of evaluation criteria, these include in particular the following:

For a given SLA (or SLS) violation, the level of severity is higher for a main agent (such as the point of access to the IP (or IP VPN) virtual private network) of the head office of a group than for a secondary agent (such as the point of access to the IP virtual private network of a subsidiary of the group),

The level of severity of a predicted SLA (or SLS) violation is more serious than that of another violation which has already occurred if the predicted violation concerns a customer which is more important than the one concerned by the violation which occurred,

For a given SLA (or SLS) violation, the level of severity is more serious if it concerns a customer having already encountered several times (or frequently) the same problem (the tolerance threshold of the problem defined in the corresponding SLS able to be reached soon),

A prediction of SLA (or SLS) violation is more significant than another violation if its reliability level (for example the level of accuracy of the prediction) is higher.

Each alarm message associated with one or several levels of severity (of violation) is then delivered to a classification module 12 of the evaluation and classification module 7, possibly after processing by a correlation (or re-evaluation) module 13, as shown on the FIGURE.

This correlation (or re-evaluation) module 13 is designed to modify at least one of the levels of severity of an alarm message delivered by the evaluation module 10 when this alarm message has at least one selected relation with at least one of the previously generated alarm messages. In fact, several alarm messages having a certain level of severity can have the same origin (or cause), for example a broken link, and due to the fact of their combination becoming more serious. The correlation module 13 is thus required to check if a level of severity is properly adapted to the problem it signals, having regard to the other alarm messages received. This checking is carried out according to one or several parameterable criteria defined by an expert of the operator, for example in the form of rules or formulae defined by data preferably stored in a second auxiliary data base 14 fed for example by the user interface 9. The rules and/or formulae contained in this second auxiliary base 14 are preferably able to be modified dynamically.

Amongst the large number of re-evaluation criteria, these include in particular the following:

Several predictions of SLS (or SLA) violations having a given cause (for example the congestion of a point of access to a service) can result in an increase of their respective levels of severity,

Several predicted or occurred SLS (or SLA) violations concerning a given customer can result in an increase of their respective levels of severity,

The increase of the frequency of the occurrence of an SLS (or SLA) violation can result in an increase of its level of severity.

If it proves to be necessary, the correlation module 13 modifies one or several severity levels of the alarm message and then sends it to the classification module 12.

This classification module 12 is designed to classify the alarm messages it receives from the evaluation module 10 or the correlation module 13 according to one of several selected classification criteria. Amongst the large number of classification criteria, these may include in particular:

Classification according to a specific customer,

Classification according to a specific service,

Classification according to urgency: the level of severity of a first predicted SLA (or SLS) violation is more important than that of a second predicted violation if the first violation must occur before the second violation,

Classification according to reliability: the level of severity of a first predicted SLA (or SLS) violation is more important than that of a second predicted violation having to occur approximately within the same time interval if the first violation has a level of reliability exceeding that of the second violation,

Classification according to the cause of an SLS (or SLA) violation: for example a classification is carried out according to the equipment (or type of equipment) causing a problem,

Classification according to the criticality of the customer: for example, customers are classified according to their order of importance for the operator,

Classification by estimated penalties following an SLS (or SLA) violation.

But it is also possible to have classification combinations, such as:

A classification per service and per customer,

A classification according to the cause of an SLS (or SLA) violation, and for each cause classification according to each customer, and for each customer classification according to each service.

These classification combinations can be represented by setting up a hierarchy of successive classifications.

The classification module preferably feeds a table storing by order of severity the various types of SLS violations having regard to the classification criteria (or additional parameters. This table is for example embodied in the form of columns associated with various classification criteria and classified according to a selected order (for example according to said hierarchy). In this case, each line of the table preferably corresponds to an SLS (or SLA) violation.

The classification criteria are preferably sent to the classification module 12 by the user interface 9 via the graphic interface 8.

Once classified by the classification module 12, the messages are sent to the graphic interface 8 so as to be displayed on the screen of the server of the operator. Display can be made according to two modes. A first mode consists of displaying the alarm messages one after the other in accordance with their classification. A second mode consists of displaying the alarm messages in accordance with their order of arrival but accompanied by information specifying their respective classifications with respect to one another. As indicated previously, the display of classifications can be carried out in a hierarchical way, especially when several classification criteria are used, possibly in combination.

The detection and control modules of the device can be respectively embodied in the form of electronic circuits, software (or computer) modules, or a combination of circuits and software.

The invention also offers a method for controlling service data inside a communications network. This can be implemented with the aid of said device. As the main and optional functions and sub-functions provided by the stages of this method are approximately identical to those provided by the various elements constituting the device, only the stages implementing the main functions of the method of the invention shall be shown.

This method consists i) of generating alarm messages in the case of the detection of a violation of at least one SLS on the basis of service data originating from the network, ii) of classification these alarm messages according to at least one selected criterion, and iii) of displaying the alarm messages according to their classification.

Before the classification operation, it is possible to associate with each alarm message at least one violation level of at least one selected type according to at least one selected evaluation criterion. This evaluation operation can be followed by a correlation (or reevaluation) operation consisting of modifying at least one of the violation levels of an alarm message when the latter has at least one selected relation with at least one of the alarm messages previously received. In this case, the alarm messages classification operation takes place after the association operation and/or the correlation operation.

By means of the invention, it is thus possible to manage, not only the alarms linked to an equipment item of the network, but also the service quality alarms linked to an SLA or SLS violation inside the network. This makes it possible to envisage the possibility of contractual indemnities or counterparts for injured party customers.

Moreover, this enables the operator of the network to concentrate solely on resolving priority problems according to the criteria of said operator.

In addition, the invention can be applied to a wide variety of data exchange networks and in particular IP, ATM and Frame Relay networks, as well as a large number of services, especially IP VPN, high flow (such as ADSL access), <<Web>> services, multimedia and 3G to the extent that a large number of classification and evaluation criteria can be used independently of the format of the SLS and implementation.

The invention is not limited to the embodiments of the methods and devices described above given solely by way of example, but it encompasses all possible variants within the context of the claims appearing hereafter.

What is claimed is:

1. Device for controlling service data inside a communications network, wherein it comprises control means arranged to classify according to a selected criterion alarm messages generated by detection means when a violation is detected of at least one specification of an SLS service level on the basis of service data originating from said network, and for delivering said classified alarm messages to a graphic interface so that they are displayed according to their classification.

2. Device according to claim 1, wherein said detection means include first analysis means arranged so as to follow up the evolution of at least some of the received service data so as to generate a predictive alarm message when said evolution is likely to result in an SLS violation.

3. Device according to claim 1, wherein said detection means include second analysis means arranged so as to determine the origin of a violation inside said network.

4. Device according to claim 1, wherein said alarm messages generated by the detection means comprise selected additional data in a group including at least one level of urgency, a violation predicting reliability level, a user identifier penalized by a violation, a service identifier penalized by a violation, a violation status, said status able to be <<predictive>> or <<occurred>>.

5. Device according to claim 1, wherein said detection means are fed by a data base with first auxiliary data defining said SLS violations.

6. Device according to claim 1, wherein said control means include evaluation means placed in such a way as to associate with each alarm message delivered by the detection means at least one violation level of at least one selected type according to at least one selected evaluation criterion.

7. Device according to claim 6, wherein said evaluation criterion is selected according to said additional data and/or second auxiliary data representative of priority levels attached to services and/or users.

8. Device according to claim 7, wherein said evaluation means are fed with second auxiliary data by a data base.

9. Device according to claim 6, wherein said evaluation means are able to be configured.

10. Device according to claim 6, wherein said control means include correlation means placed in such a way as to modify at least one of the violation levels of an alarm message delivered by the evaluation means and having at least one selected relation with at least one of the alarm messages previously received.

11. Device according to claim 10, wherein said correlation means are able to be configured.

12. Device according to claim 9, wherein at least one of said evaluation means of said correlation means is able to be configured with the aid of data defining rules.

13. Device according to claim 6, wherein said control means include classification means placed in such a way so as to classify said alarm messages associated with at least one type of violation level according to at least one selected classification criterion.

14. Device according to claim 13, wherein said classification means comprise a table storing the various types of SLS violation according to said classification criterion.

15. Device according to claim 13, wherein said classification criterion relates to at least the various violation levels.

16. Device according to claim 13, wherein said classification criterion relates to at least one additional parameter stored in said table.

17. Device according to claim 16, wherein said graphic interface is able when ordered by an operator to transmit to said classification means said additional parameters.

18. Device according to claim 13, wherein said classification means are placed in such a way so as to classify said alarm messages according to at least two selected classification criteria.

19. Device according to claim 18, wherein in the presence of at least two classification criteria, said classification means are placed in such a way so as to carry out a hierarchical classification.

20. Device according claim 5, wherein it includes said data base.

21. Device according to claim 1, wherein it includes said detection means.

22. Device according to claim 1, wherein said control means include the graphic interface.

23. Method for controlling service data inside a communications network, wherein it consists of i) generating alarm messages when a violation is detected of at least one SLS service level violation on the basis of service data originating from said network, ii) classifying said alarm messages according to at least one selected criterion, and iii) displaying said alarm messages according to their classification.

24. Method according to claim 23, wherein evolution is followed up of at least some of the received service data so as to generate a predicting alarm message when said evolution is likely to result in an SLS violation.

25. Method according to claim 23, wherein the origin of a violation inside said network is determined before generating an alarm message.

26. Method according to claim 23, wherein said alarm messages comprise additional data selected from a group including at least one urgency level, one violation prediction reliability level, one user identifier penalized by a violation, one service identifier penalized by a violation, one status violation, said status able to be <<predictive>> or <<occurred>>.

27. Method according to claim 23, wherein prior to the classification operation, at least one violation level of at least one selected type is associated with each alarm message according to at least one selected evaluation criterion.

28. Method according to claim 27, wherein said evaluation criterion is selected according to said additional data and/or second auxiliary data representative of priority levels attached to services and/or users.

29. Method according claim 27, wherein after the violation level association operation, at least one of the violation levels of an alarm message is modified having at least one selected relation with at least one of the previously received alarm messages.

30. Method according to claim 27, wherein after the association and/or modification operation, said alarm messages associated with at least one type of violation level is classified according to at least one selected classification criterion.

31. Method according to claim 30, wherein the various types of SLS violation are stored in a table according to said classification criterion.

32. Method according to claim 30, wherein said classification criterion relates to at least the various violation levels.

33. Method according to claim 30, wherein said classification criterion relates to at least one additional parameter stored in said table.

34. Method according to claim 30, wherein the classification operation is carried out according to at least two classification criteria.

35. Method according to claim 34, wherein in the presence of at least two classification criteria, said classification operation is carried out by hierarchical means.

36. Use of methods and device according to one of the preceding claims in selected networks from public and private networks.

37. Use according to claim 36, wherein the network is selected from a group including Internet (IP), ATM and Frame Relay networks.

38. Use according to claim 36 for the control of services selected from a group including at least IP VPN, high flow, <<Web>> services, multimedia and 3G.
